(19) United States
(12) Patent Application Publication
(10) Pub. No.: US 2010/0096507 A1
(43) Pub. Date: Apr. 22, 2010

(54) HEATING DEVICE FOR DEICING AIRCRAFT PARTS

(76) Inventor: Markus Villinger, Mieders (AT)

Correspondence Address: LERNER GREENBERG STEMER LLP, P O BOX 2480, HOLLYWOOD, FL, 33022-2480, US

(21) Appl. No.: 12/511,670

(22) Filed: Jul. 29, 2009

(30) Foreign Application Priority Data
Jul. 29, 2008 (AT) A 1173/2008

(51) Int. Cl. B64D 15/12; B60L 1/02

(52) U.S. Cl. 244/134 D; 219/202

(57) ABSTRACT

A deicing pad for attachment to an aircraft, in particular to wings, propellers or helicopter rotors, that are formed with an attachment surface for the deicing pad to rest flat on the aircraft. The deicing pad has a heating layer and at least two electrodes which make electrical contact with the heating layer. The heating layer has a layer composed of an electrically conductive lacquer that forms the heating element.

CROSS-REFERENCE TO RELATED APPLICATION

This application claims the priority, under 35 U.S.C. § 119, of Austrian application A 1173/2008, filed Jul. 29, 2008; the prior application is herewith incorporated by reference in its entirety.

### BACKGROUND OF THE INVENTION

1. Field of the Invention:

The present invention relates to a deicing pad for attachment to aircraft, in particular to fixed wings or airfoils, propellers or helicopter rotors, having an attachment surface for the deicing pad to rest flat on the aircraft, having a heating layer and having at least two electrodes which make electrical contact with the heating layer.

Deicing pads such as these are used to prevent icing of those parts of aircraft to which they are attached. Depending on the weather conditions, the deicing pads can completely prevent ice formation, or can at least keep it within an acceptable range. An already existing ice layer can also be heated away after activation of the ice pad. Since icing is particularly problematic in particular on those aircraft parts which are responsible for the generation of lift or the lift force (wings, airfoils, propellers, helicopter rotors or the like), these parts represent the main field of use, of course, for the use of the deicing pads.

Deicing pads of this generic type according to the prior art generally produce the required heat in the heating layer by means of a wire mesh, which is heated by the electric current passed through it during operation. Deicing pads such as these are relatively thick, which results in the problem that, particularly when used on the lift-generating aircraft parts, this can result in an undesirable influence on the aerodynamic characteristics of these aircraft parts.

In addition, it has already become known for aircraft parts to be provided directly with a heating layer. Reference is had, in this context to U.S. Pat. No. 3,800,121 and British patent specification GB 1 386 792; to British patent specification GB 662 540; and to British patent specification GB 488 820. There, the heating layer is applied directly in the form of an electrically conductive lacquer to the aircraft part to be kept free of ice. This is associated with the disadvantage that the equipment of aircraft with heating layers such as these, and the servicing or repair of the heating layers, results in the aircraft being unused for a relatively long time, which is nowadays unacceptable, particularly for financial reasons.

### SUMMARY OF THE INVENTION

It is accordingly an object of the invention to provide a device for deicing aircraft which overcomes the above-mentioned disadvantages of the heretofore-known devices and methods of this general type and which provides for deicing pads of the generic type that can be used without adversely affecting the aerodynamic characteristics of the aircraft part to which they are attached.

With the foregoing and other objects in view there is provided, in accordance with the invention, a deicing pad for attachment to an aircraft formed with an attachment surface for supporting the deicing pad in contact therewith, comprising:

a heating layer having a layer composed of an electrically conductive lacquer forming a heating element; and

at least two electrodes making electrical contact with the heating layer for heating the heating layer by injecting an electrical current into the electrically conductive lacquer.

The deicing pad is particularly suited for aircraft wings (fixed wings, adjustable wings, airfoils), propeller blades, or helicopter rotor blades. In a preferred embodiment, the heating layer is configured to rest flat on and in surface contact with the aircraft part to be deiced.

In accordance with an added feature of the invention, the heating layer is mounted on a mount layer carrying the heating layer. In a preferred embodiment, the mount layer is composed of a textile fabric or a film. It is further preferred for the mount layer to project circumferentially from below the heating layer.

In accordance with an additional feature of the invention, there is provided an insulating layer disposed underneath the heating layer and configured to thermally and/or electrically insulate the heating layer from the attachment surface on the aircraft.

In accordance with another feature of the invention, there may be provided a protective layer covering the heating layer.

In accordance with a further feature of the invention, the heating layer is sprayed or printed, for example screen-printed, onto the mount layer.

In accordance with again an added feature of the invention, the layer of electrically conductive lacquer has a substantially uniform thickness, at least substantially over an entire extent of the heating layer. Alternatively, the layer of electrically conductive lacquer has a thickness profile with a greatest thickness approximately at a center of the heating layer. The thickness or the thickness profile for the layer of lacquer is chosen as a function of a desired heating power of the deicing pad.

In accordance with again an additional feature of the invention, the conductivity and electrical resistance of the lacquer are mixed so as to define a current draw and a heating power at a predetermined electrical voltage.

In accordance with yet another feature of the invention, the lacquer is a water-soluble acrylic lacquer. Furthermore, the lacquer may include an electrically conductive component formed from particles selected from the group consisting of a polymer having a conductive or semiconductive substance, graphite particles, or silver particles. In a further embodiment, the lacquer is polyurethane based or it is epoxy resin.

With the above and other objects in view there is provided, in accordance with the invention, an aircraft part, comprising:

a surface subject to potential icing upon use of the aircraft;

a heating element having a layer composed of electrically conductive lacquer forming a heating layer disposed to heat the surface; and

at least two electrodes in electrical contact with the electrically conductive lacquer.

In accordance with a concomitant feature of the invention, the heating element and the electrodes form a deicing pad and a surface of the deicing pad lies flush a surface of the aircraft part surrounding the deicing pad.

By way of example, the lacquer which has already been described in the prior art referred to above may be used as an electrically conductive lacquer. Electrically conductive lacquers which are suitable for the invention are also referred to as resistance lacquers. One suitable lacquer is also disclosed, for example, in Swiss patent CH 468 702, entitled “electrical resistance mass.”

The invention makes it possible to provide thin deicing pads which have scarcely any influence on the aerodynamic characteristics of the aircraft part provided with it or them. The already very minor adverse effects on the aerodynamic characteristics which are intrinsic on the basis of the invention in any case can also be decreased or even reduced to zero by appropriately preparing the aircraft part to which the deicing pad is intended to be attached. For example, the aircraft part can be ground in corresponding to the thickness of the deicing pad, which is very thin in any case, such that the deicing pad ends flush with that surface of the aircraft part (generally plastic, metal or a lacquer layer) which surrounds the deicing pad.

In accordance with another feature of the invention, the deicing pad is formed of glass fiber mats soaked in epoxy resin with electric components added. Such mats become very rugged and the heatable glassfiber mats are easily molded and applied to a variety of parts.

In accordance with an added feature of the invention, the electrically conductive lacquer is applied directly to the aircraft part and becomes an integral part with it.

Other features which are considered as characteristic for the invention are set forth in the appended claims.

Although the invention is illustrated and described herein as embodied in a heating device for deicing aircraft parts, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective schematic view of a deicing pad according to the invention;

FIGS. 2A, 2B are cross-sections taken along the line II-II in FIG. 1, showing two different exemplary embodiments of a deicing pad illustrated with exaggerated thickness;

FIG. 3 shows the implementation of a deicing pad according to the invention on an aircraft part in the form of a propeller blade; and

FIG. 4 shows the implementation of two deicing pads according to the invention on an aircraft part in the form of a helicopter rotor blade

FIG. 5 illustrates the positive temperature coefficient of the lacquer.

### DETAILED DESCRIPTION OF THE INVENTION

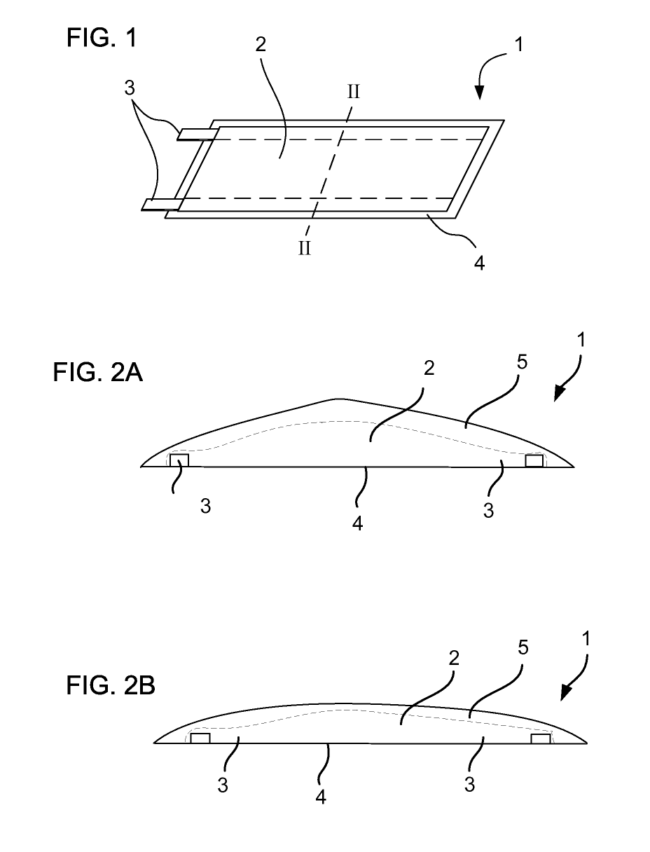

Referring now to the figures of the drawing in detail and first, particularly, to FIG. 1 thereof, a deicing pad 1 according to the invention has heating layer 2 that is entirely composed of a layer of an electrically conductive lacquer. In principle, it would also be feasible to fit additional heat-generating elements in the heating layer, although it would be necessary to ensure that the thickness of the deicing pad did not increase excessively.

In the illustrated exemplary embodiment, the heating layer 2 is arranged on a mount layer 4 (in this case composed of a textile fabric). Other material may, of course, also be used for the mount layer 4, for example plastic or else a metallic material coated with some suitable insulation.

As shown, the mount layer 4 can preferably project on all sides under the heating layer 2 thus forming a preferably circumferential edge, which insulates the heating layer 2 from the aircraft part. The latter is not illustrated in FIG. 1.

Two electrodes 3, which are in the form of strips and may be formed, for example, from copper strip, silver lacquer, wire mesh or from some other suitable material, run along the longitudinal side of the deicing pad 1. The heating layer 2 makes contact with the electrodes 3, as a result of which a current flows from one electrode 3 via the lacquer layer to the other electrode 3 when an electrical voltage (which is obtained in use from the aircraft power supply system) is applied to the two electrodes 3. In the process, the heating layer 2 is heated in a manner known per se, thus resulting in the function of the deicing pad 1.

In addition, an insulating layer which thermally and/or electrically insulates the heating layer 2 from the aircraft in the in-use position, can be arranged under the heating layer 2. However, in the illustrated exemplary embodiment, this insulating layer is already formed by the mount layer 4.

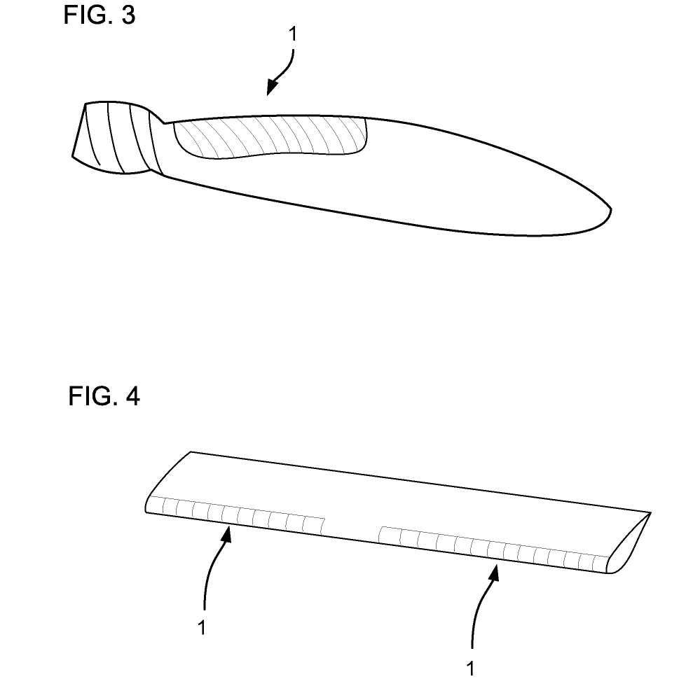

FIG. 1 does not illustrate a protective layer 5 (see FIG. 2) which covers the deicing pad 1 on top (that is to say facing away from the aircraft part in the in-use position) and which is used in particular to protect the heating layer 2 against mechanical erosion. The protective layer 5 preferably covers the entire surface of the deicing pad 1. However, it is also possible to provide for the protective layer 5 to extend only over the heating layer 2. The protective layer 5 is, of course, not absolutely essential when either a limited life of the deicing pad 1 is acceptable or a lacquer with appropriate mechanical resistance is used.

The heating layer 2 can be sprayed or printed, preferably using the screen-printing method, onto the mount layer 4. The heating layer 2 can also be applied manually to the mount layer 4.

In a first variant (FIG. 2B), the lacquer layer (and therefore the heating layer 2 in the illustrated exemplary embodiment) has a substantially uniform thickness at least substantially over the entire extent of the heating layer 2.

In a second variant of the invention (FIG. 2A), the lacquer layer has a varying thickness, with the size and thickness of the lacquer layer being chosen such that the thickest point in the in-use position is arranged where icing of the aircraft part would have the most serious consequences. Since most deicing pads 1 are fitted over approximately half their extent along the longitudinal edge of an airfoil, a propeller or a helicopter rotor (see FIGS. 3 and 4), the thickness of the lacquer layer should be at its greatest approximately at half the extent of the heating layer 2. This means that the greatest heating of the heating layer 2 occurs there.

In an entirely general form, it can be stated that one fundamental ideal of one variant of the invention is to choose the thickness or the thickness profile for the lacquer layer as a function of the desired heating power of the deicing pad 1.

This will be illustrated using a brief example:

The current draw (heating power) can be adjusted with respect to the electrical voltage that is intended to be applied by means of the applied layer thickness (and/or by means of an appropriate mixture of the heating lacquer), corresponding to the area of the heating layer 2 and the distance between the electrodes 3.

For example, if one assumes a deicing pad 1 for heating a propeller with a diameter of 180 cm (which represents a typical propeller size for a four-seater, single-engine aircraft), then one deicing pad 1 with a heating area of, for example, 30 cm×7 cm should be provided for each propeller blade, in which case the deicing pad 1 should be fitted around the leading edge of the propeller blade, at the base of the propeller blade. As a result of the centrifugal forces that occur during operation, there is in any case scarcely any significant ice accumulation on those areas of the propeller blade which are located farther outward.

If the aircraft supply voltage is assumed to be 24 volts, and a desired temperature of the deicing pad 1 is assumed to be 90° C. when the outside temperature is 15° C., then this corresponds to a desired power consumption of 60 watts.

As trials by the applicant have shown, it is sufficient to apply an approximately 3 μm thick layer of a heating lacquer on an acrylic basis (water-soluble acryl emulsion) with an approximately 60% component of graphite, in order to provide the desired heating power. By way of example, a layer such as this can be formed by two coats with the aid of a brush or by three or four coats with the aid of a spray gun.

The precise required thickness or the required thickness profile (where it is intended to be thicker, more heating lacquer is applied) also depends, of course, on the precise composition of the lacquer. However, those of skill in the pertinent art will have no undue problems in calculating or finding the desired layer thickness of the lacquer by a small number of trials, based on the available lacquer.

FIG. 3 shows the use of a deicing pad 1 that has been produced in this way on an aircraft part in the form of a propeller.

By way of example, FIG. 4 shows the application of two deicing pads 1 to a rotor blade of a helicopter rotor.

Further options for use, which are not illustrated, include, for example, air inlet and outlet apparatuses.

The lacquer used here is unique and it has special features. For example, the heating lacquer is an intrinsically conductive polymer with electrically positive temperature coefficient. That is, it is self-regulated or close-loop controlled. The resultant safety in the context of the airplane application is specifically noted. According to the chemical composition, the current requirement is decreased at higher temperatures. That is, unnecessary current consumption of the deicing pad can be avoided even without or also on failure of any special electronic components.

On the contrary, electrically conductive polymers are known that are constructed on CNT (carbon nanotube) basis or similar, the configuration of which is thus that they have a negative electrical temperature coefficient, which in fact establishes a security risk. Similarly, polymers on the CNT basis are subject to oxidation if they are not optimally insulated. Due to external influences, however, such perfect insulation is nearly impossible to achieve.

The heating lacquer used in the instant system—intrinsically conductive polymer—is particularly sturdy and it is also environmentally friendly.

More specifically, the lacquer is particularly advantageous because it consists of conductive or semiconductive particles homogeneously distributed in a silicone-rubber. Only some of the particles are in contact with one another so as to form a current-conductive path.

Conductive or semiconductive materials include, for example, soot, graphite, metal powder, silcon carbide, aluminum antimonide, lead sulfide, cadmium sulfide, and/or germanium.

It should also be noted that silicones are very good insulators. Their specific resistance, however, decreases very quickly when only small amounts of conductive or semiconductive admixtures are present.

Due to the fact that the admixtures are present without through-conductance and without mutual contact throughout within the carrier material, there is no complete skeleton formation and also no continuous skeleton conductance. Only defective conductive paths are formed. This leads to a great positive temperature coefficient of the electrical resistance, which can be adjusted with a suitable choice of materials. A small amount of skeleton current conduction raises the overall conductance and it decreases the temperature coefficient.

Admixing further silicones in the form of oils or resins, or of silicone-file artificial resins (e.g., alkyd resins), the temperature coefficient may be influenced.

The amount of catalysts that are added also influences the conductivity of the lacquer.

Such lacquers are particularly suitable for used as a resistance lacquer for electrical planar or layer resistors.

It goes without saying that the resultant lacquer has very specific advantages. It is very elastic and it is very resistant against erosion. It does not expand to a great degree and it adheres superbly on a carrier material. Also it is chemically very stable and it is water resistant. Finally, it shows superior aging qualities, mechanical resistance, and electrical resistance against arcing.

In a preferred production method, siloxanes with conductive or semiconductive particles are homogeneously distributed in a mass, so that no conductive mutual contact is formed between the particles. This leads to the polymerization of the silicone rubber.

Depending on the desired viscosity of the lacquer, the siloxanes may be introduced in a solvent or also in the form of solvent-free paste.

The following lists provide for two exemplary embodiments of the lacquer:

### Example 1

290 parts by weight xylol and athyl acetate
100 parts by weight dimethyl polysilixane
1.3 parts by weight soot (particle size less than 0.1)
55 parts by weight graphite
0.5 parts by weight silicone oil
0.3 parts by weight catalyst (for polymerization)

### Example 2

210 parts by weight athyl acetate
100 parts by weight dimethylpolysiloxane
50 parts by weight aluminum antimonide
1 parts by weight soot
0.3 parts by weight catalyst

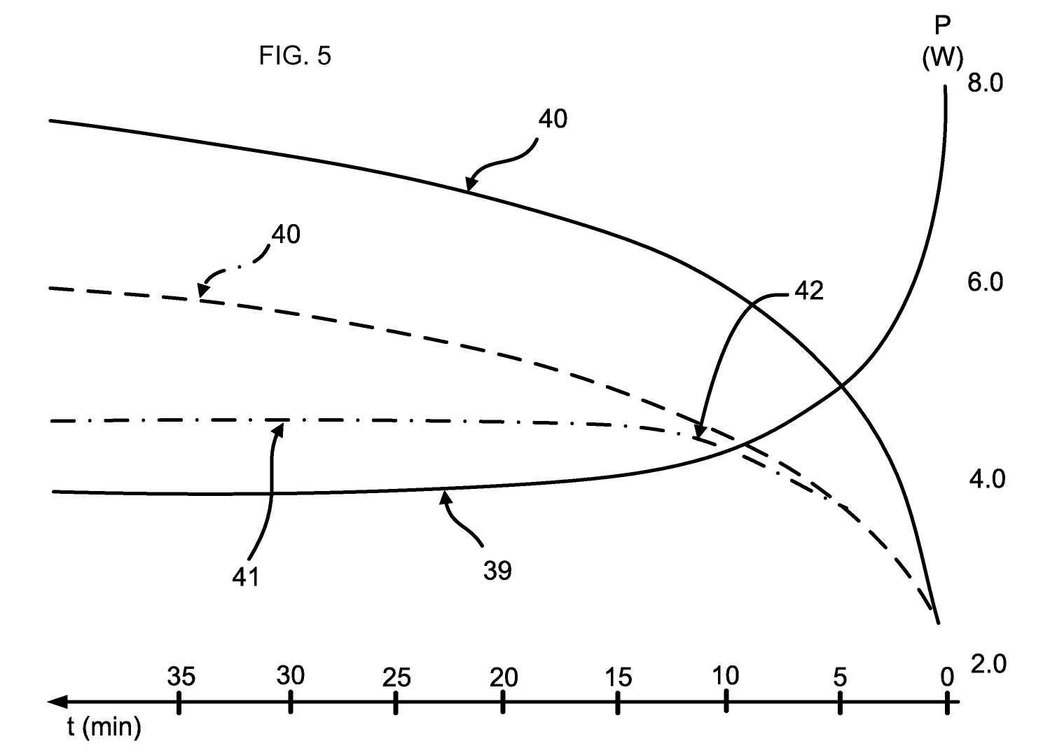

FIG. 5 illustrates the positive temperature coefficient of the lacquer. The diagram illustrates the power input and the temperature in dependence on time. The power consumption in dependence on time and the course of the temperature relative to the power consumption of the heating lacquer are illustrated with reference to the areal heating element (i.e., the pad). As illustrated by the characteristic curve 39, the heat intake of the heating element decreases with increasing time due to the rise in the temperature and the corresponding increase in the resistance in the electrically conducting polymer. This leads to a closed-loop control and automatic stabilization of the heating element. The control is effected by the adjustment of the electrically conducting polymer and its limit temperature. The temperature course of the heating element, with ideal heat insulation is illustrated by the line 40 (solid line). The characteristic line shows the temperature course of the areal heating element when heat is conducted off. The example reaches its temperature stabilization at approx. 50 degrees Celsius.

The characteristic curve 41 shows that the electrically conductive polymer may be chosen such that it leads to a non-linear temperature coefficient of the electrical resistance. The step 42 in the curve 41 illustrates the strong increase of the resistance after the limit temperature has been reached. The effect is a jump in the resistance in the electrically conductive polymer and a corresponding decrease in the power consumption. After a relatively short heating period, there follows a very fast temperature stabilization in the areal heating element. This characteristic curve as well shows the temperature course while heat is conducted off from the element. Advantageously, the bend in the characteristic curve is at the desired temperature.

We found that one of the primary problems concerning aircraft icing has to do with runback ice. Propellers are generally deiced with electrically created heat. The ice is thereby melted off the props and the water flows backward, where it once more forms ice just backward of the props.

The deicing pads (i.e., ice pads) according to the invention may be mounted in a flexible manner, with different type of heating in order to also fight different types of ice formation. The flexible availability of the novel deicing pad renders it possible to react to any type of formation. For example, conventional propellers with a relative large radius and relatively slow rotation (e.g., turboprop engines of short hop flight patterns) very often lead to the runback icing problem. Re-frozen ice behind the propeller leads to great difficulties. The deicing pads according to the invention allow mounting at any point and they may be mounted with full area coverage—including areas with a variety of heating requirements—in order to fully avoid the safety issues surrounding the runback ice.

1. A deicing pad for attachment to an aircraft formed with an attachment surface for supporting the deicing pad in contact therewith, comprising:
a heating layer having a layer composed of an electrically conductive lacquer forming a heating element; and
at least two electrodes making electrical contact with said heating layer for heating the heating layer by injecting an electrical current into said electrically conductive lacquer.

2. The deicing pad according to claim 1 configured for attachment to an attachment surface formed on an aircraft wing, a propeller blade, or a helicopter rotor blade.

3. The deicing pad according to claim 1, wherein said heating layer is configured to rest flat on and in surface contact with a aircraft part to be deiced.

4. The deicing pad according to claim 1, which further comprises a mount layer carrying said heating layer.

5. The deicing pad according to claim 4, wherein said mount layer is composed of a textile fabric or a film.

6. The deicing pad according to claim 4, wherein said mount layer projects circumferentially from below said heating layer.

7. The deicing pad according to claim 1, which further comprises an insulating layer disposed underneath said heating layer and configured to thermally and/or electrically insulate said heating layer from the attachment surface on the aircraft.

8. The deicing pad according to claim 1, which further comprises a protective layer covering said heating layer.

9. The deicing pad according to claim 4, wherein said heating layer is a sprayed or printed layer formed on said mount layer.

10. The deicing pad according to claim 4, wherein said heating layer is a printed layer screen-printed onto said mount layer.

11. The deicing pad according to claim 1, wherein said layer of electrically conductive lacquer has a substantially uniform thickness, at least substantially over an entire extent of said heating layer.

12. The deicing pad according to claim 11, wherein the thickness for said layer of lacquer is chosen as a function of a desired heating power of the deicing pad.

13. The deicing pad according to claim 1, wherein said layer of electrically conductive lacquer has a greatest thickness approximately at a center of said heating layer.

14. The deicing pad according to claim 11, wherein a thickness profile for said layer of lacquer is chosen as a function of a desired heating power of the deicing pad.

15. The deicing pad according to claim 1, wherein a conductivity and an electrical resistance of said lacquer are adjusted so as to define a current draw and a heating power at a predetermined electrical voltage.

16. The deicing pad according to claim 1, wherein said lacquer is a water-soluble acrylic lacquer, a polyurethane, or an epoxy resin.

17. The deicing pad according to claim 1, which comprises glass fiber mats soaked in epoxy resin with electric components added.

18. The deicing pad according to claim 1, wherein said lacquer includes an electrically conductive component formed from particles selected from the group consisting of a polymer having a conductive or semiconductive substance, graphite particles, or silver particles.

19. An aircraft part, comprising:
a surface subject to potential icing upon use of the aircraft;
a heating element having a layer composed of electrically conductive lacquer forming a heating layer disposed to heat the surface; and
at least two electrodes in electrical contact with said electrically conductive lacquer.

20. The aircraft part according to claim 18, wherein said heating element and said electrodes are components of a deicing pad and a surface of said deicing pad lies flush a surface of the aircraft part surrounding said deicing pad.

21. In combination, an aircraft part selected from the group consisting of an aircraft wing, a propeller blade, a helicopter rotor, and air inlet or air outlet apparatus, and a deicing pad according to claim 1 disposed on said aircraft part and operable to selectively deice said aircraft part.
